(19) United States
(12) Patent Application Publication
(10) Pub. No.: US 2020/0378610 A1
(43) Pub. Date: Dec. 3, 2020

(54) SAFETY APPARATUS INCLUDING SENSOR AND REMOTE CONTROLLED STOVE KNOB

(71) Applicants: Nadia J. Williams, Winnipeg (CA); Nadia DM Williams, Wesley Chapel, FL (US)

(72) Inventors: Nadia J. Williams, Winnipeg (CA); Nadia DM Williams, Wesley Chapel, FL (US)

(21) Appl. No.: 16/884,624

(22) Filed: May 27, 2020

Related U.S. Application Data
(60) Provisional application No. 62/853,321, filed on May 28, 2019.

(51) Int. Cl. F24C 3/12; F24C 7/08; G05G 1/10

(52) U.S. Cl. CPC F24C 3/126; F24C 3/124; G05G 2700/02; G05G 1/10; F24C 7/083

(57) ABSTRACT

The apparatus includes remote controlled knobs with a safety sensor. The knobs are configured for universal use and replace the existing knobs on a stove. Motorized gears in the knob are configured to rotate the knob to the off position and turn the burner off from a remote location though an application hosted on an electronic device. The sensor is fastened to a surface above the stove by adhesive and is adapted to sense, though an infrared sensor, the presence of a dangerous condition. The sensor includes a camera and heat sensor communicating with the application to verify that the stove is off, or if not off enable a user or turn it off. The sensor includes a plurality of adjustable, infrared temperature sensors which are angled at the burners. The heat sensors enable monitoring and may turn off the stove top when an unsafe heat level is reached.

This application claims the benefit under 35 U.S.C. 119(e) of U.S. provisional application Ser. No. 62/853,321, filed May 28, 2019.

### FIELD OF THE INVENTION

The present invention relates to a safety apparatus for controlling operation of a stove to shut off the burners of the stove in response to detection of a dangerous condition, and more particularly the present invention relates to a safety apparatus including sensors to detect a dangerous condition, a plurality of remote controlled knobs for mounting on the stove and an application executable on an electronic device for notifying a user of the dangerous condition.

### BACKGROUND

Currently there are a number of solutions for monitoring a stove's burner. One of these solutions attempts to set an alarm when a set time has passed, but this solution fails to meet the needs of the market because the user may not hear the alarm. Another solution attempts to rely on a smoke detector, but this solution is similarly unable to meet the needs of the market because a fire or a lot of smoke has already occurred. Still another solution seeks to double check the burners, but this solution also fails to meet market needs because users may forget or not be present within the residence or space to double check.

### SUMMARY OF THE INVENTION

It would be advantageous to have an apparatus that monitors the heat from a stove top. Furthermore, it would also be advantageous to have an apparatus that was configured remotely to turn stove tops or ovens off. Still further, it would be advantageous to have an apparatus that sensed dangerous heat levels and turned the appliance off. Therefore, there currently exists a need in the market for an apparatus that monitors stove top appliances remotely from a smart device.

The invention advantageously fills the aforementioned deficiencies by providing a remote controlled stove knob with integrated safety sensor coupled to an application which provides a user the ability to turn the appliance off from a remote location.

The apparatus fulfils the need for ensuring the stove top is shut off.

Among other things, it is an advantage of the invention to provide a remote controlled stove knob with safety sensor that does not suffer from any of the problems or deficiencies associated with prior solutions.

It is still further an advantage of the invention to sense a dangerous condition.

According to one aspect of the invention there is provided an apparatus for use with an electronic device for controlling operation of a stove having a stove housing and a cooking surface supporting two or more burner assemblies thereon, each burner assembly including a burner for cooking and an operational shaft associated with the burner to control a heating level of the burner, the apparatus comprising:

an application comprising programming instructions arranged to be executed by the electronic device;

a plurality of remote controlled knobs arranged to be operatively connected to the operational shafts of the burner assemblies respectively;

a safety sensor arranged to be supported above the stove so as to be configured to sense a dangerous condition;

a main controller operatively connected to the safety sensor so as to be arranged to notify the application of the dangerous condition;

the application being configured to generate a user prompt responsive to notification of the dangerous condition and generate an instruction signal for the main controller to instruct one or more of the remote controlled knobs to turn off the operational shaft connected thereto based upon a user response to the user prompt. In some embodiments, the application is configured to instruct the one or more remote controlled knobs to turn off the operational shaft connected thereto based upon the user response being a confirmation that the user is not in proximity to the stove.

In some embodiments, the application is configured to instruct the one or more remote controlled knobs to turn off the operational shaft connected thereto based upon the user response being non-responsive to the user prompt.

Preferably the safety sensor comprises a plurality of infrared sensors associated with respective portions of the cooking surface, each infrared sensor being configured to measure heat being emitted by the respective portion of the cooking surface and determine the dangerous condition if the measured heat from any one infrared sensor exceeds a prescribed heat threshold. The instruction signal may be associated with all of the remote controlled knobs such that all of the remote controlled knobs are instructed to be turned off by the main controller in response to determination of the dangerous condition by any one of the infrared sensors.

When the safety sensor comprises a sensor housing and a plurality of infrared sensors commonly mounted on the sensor housing, the infrared sensors are preferably adjustable in orientation relative to the sensor housing whereby each infrared sensor can be associated with a respective portion of the cooking surface such that each infrared sensor is configured to measure heat being emitted by the respective portion of the cooking surface and determine the dangerous condition if the measured heat from that infrared sensor exceeds a prescribed heat threshold.

The safety sensor preferably further comprises an activation button supported on the sensor housing, in which the infrared sensors are inoperative until commonly activated by depressing the activation button on the sensor housing. The sensor housing comprises (i) a rear wall including an adhesive layer thereon so as to be arranged to adhere the sensor housing to an upright supporting surface adjacent to the stove and (ii) a front wall that is sloped upwardly and outwardly away from the rear wall, wherein the front wall supports the plurality of infrared sensors thereon.

A camera may also be supported on the sensor housing so as to be configured to capture an image of the burner assemblies and communicate the image to the application. The image may be captured and communicated to the application in response to determination of the dangerous condition, or alternatively the image may be captured and communicated to the application in response to a request signal from the application.

Each remote controlled knob according to the preferred embodiment comprises: (i) a gripping portion supported on the respective operational shaft of the stove externally of the stove housing so as to be arranged to be gripped in a hand of a user; (ii) a base portion arranged to be fixed relative to the stove housing; (iii) a knob motor arranged to drive rotation of the gripping portion and the operational shaft connected thereto relative to the stove housing; and (iv) a knob controller arranged to activate the knob motor in response to the instruction signal.

The gripping portion of each knob may comprise a main body including (i) a shaft mounting socket that directly mounts the gripping portion on the respectively operational shaft of the stove and (ii) a driven portion directly coupled to an output of the knob motor to drive rotation of the operational shaft directly through the gripping portion. The driven portion of the main body of the knob preferably comprises a ring gear and the output of the knob motor preferably comprises a spur gear in meshing engagement with the ring gear.

The main body of the knob preferably comprises a single unitary body forming both the shaft mounting socket and the ring gear integrally thereon.

The base portion of the knob includes an adhesive layer thereon so as to be arranged to adhere the base portion to the stove housing.

According to another aspect of the present invention there is provided an apparatus for controlling operation of a stove having a stove housing and a cooking surface supporting two or more burner assemblies thereon, each burner assembly including a burner for cooking and an operational shaft associated with the burner to control a heating level of the burner, the apparatus comprising:

a plurality of remote controlled knobs arranged to be operatively connected to the operational shafts of the burner assemblies respectively;

a safety sensor arranged to be supported above the stove so as to be configured to sense a dangerous condition;

the safety sensor comprising (i) a sensor housing and (ii) a plurality of infrared sensors commonly mounted on the sensor housing so as to be associated with respective portions of the cooking surface;

each infrared sensor being configured to measure heat being emitted by the respective portion of the cooking surface and determine a dangerous condition if the measured heat exceeds a prescribed heat threshold;

a main controller in operative communication with the remote controlled knobs and the safety sensor so as to be arranged to transmit an instruction signal to the remote controlled knobs to turn off the knobs in response to determination of the dangerous condition by any one of the infrared sensors.

The safety sensor may further comprise an activation button supported on the sensor housing such that the plurality of infrared sensors are inoperative until commonly activated by depressing the activation button on the sensor housing.

The sensor housing may comprises (i) a rear wall including an adhesive layer thereon so as to be arranged to adhere the sensor housing to an upright supporting surface adjacent to the stove and (ii) a front wall that is sloped upwardly and outwardly away from the rear wall, wherein the front wall supports the plurality of infrared sensors thereon such that the infrared sensors are arranged to be directed downwardly and forwardly onto the cooking surface of the stove.

According to another aspect of the present invention there is provided an apparatus for use with an electronic device for controlling operation of a stove having a stove housing and a cooking surface supporting two or more burner assemblies thereon, each burner assembly including a burner for cooking and an operational shaft associated with the burner to control a heating level of the burner, the apparatus comprising:

a safety sensor arranged to be supported above the stove so as to be configured to sense a dangerous condition;

a plurality of remote controlled knobs arranged to be operatively connected to the operational shafts of the burner assemblies respectively;

a main controller in operative communication with the remote controlled knobs and the safety sensor so as to be arranged to transmit an instruction signal to the remote controlled knobs to turn off the knobs in response to determination of the dangerous condition by the safety sensor;

each remote controlled knob comprising:
(i) a gripping portion supported on the respective operational shaft of the stove externally of the stove housing so as to be arranged to be gripped in a hand of a user;
(ii) a base portion arranged to be fixed relative to the stove housing;
(iii) a knob motor arranged to drive rotation of the gripping portion and the operational shaft connected thereto relative to the stove housing; and
(iv) a knob controller arranged to activate the knob motor in response to the instruction signal from the main controller;
(v) the gripping portion of each knob comprising a main body including (a) a shaft mounting socket that directly mounts the gripping portion on the respectively operational shaft of the stove and (b) a driven portion directly coupled to an output of the knob motor to drive rotation of the operational shaft directly through the gripping portion, the driven portion of the main body of the knob comprises a ring gear;
(vi) the output of the knob motor comprises a spur gear in meshing engagement with the ring gear;

wherein the main body of the knob comprises a single unitary body forming both the shaft mounting socket and the ring gear integrally thereon.

### BRIEF DESCRIPTION OF THE DRAWINGS

Some embodiments of the invention will now be described in conjunction with the accompanying drawings in which:

FIG. 1 is a perspective view of the safety apparatus shown mounted on a stove and in communication with a user electronic device;

FIG. 2 is a schematic representation of the various components of the safety apparatus;

FIG. 3 is a side view of the safety sensor of the apparatus according to FIG. 1;

FIG. 4 is a top plan view of the safety sensor;

FIG. 5 is a front elevational view of the safety sensor;

FIG. 6 is a perspective view of one of the remote controlled knobs of the apparatus according to FIG. 1;

FIG. 7 is a top view of the remote controlled knob;

FIG. 8 is a side view of the remote controlled knob, in which the opposing side view is a mirror image;

FIG. 9 is a front view of the remote controlled knob;

FIG. 10 is a rear perspective view of the remote controlled knob;

FIG. 11 is a section view along the line 11-11 in FIG. 10; and

FIG. 12 is an exemplary screenshot of the application when executed on the user electronic device according to the apparatus of FIG. 1.

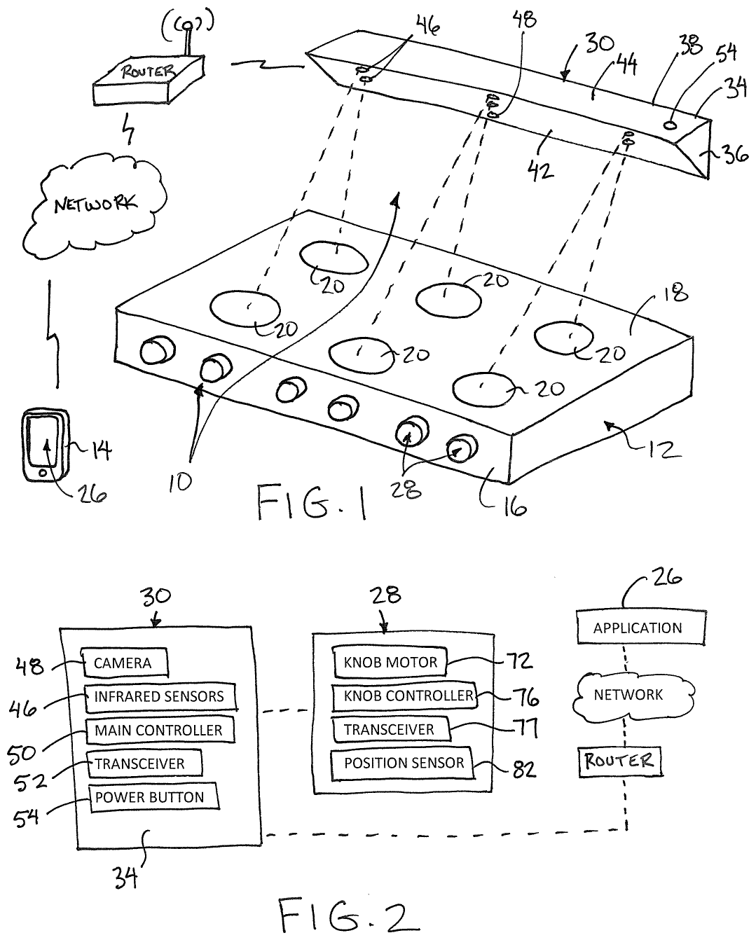

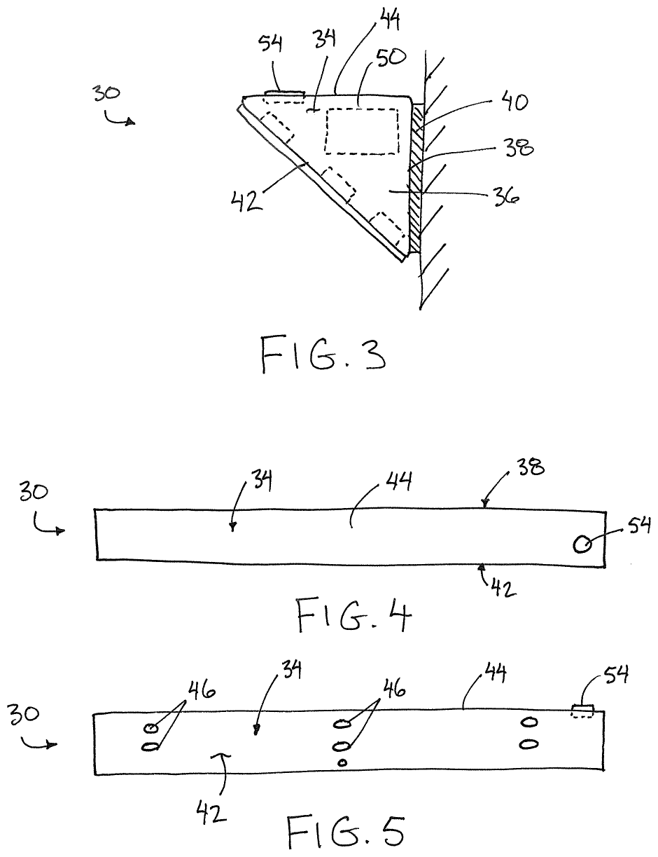

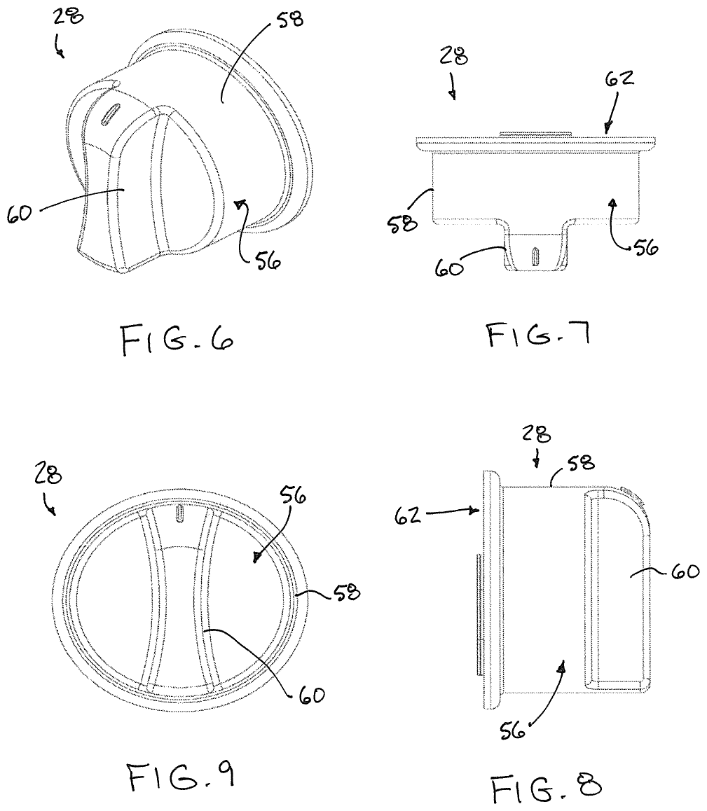

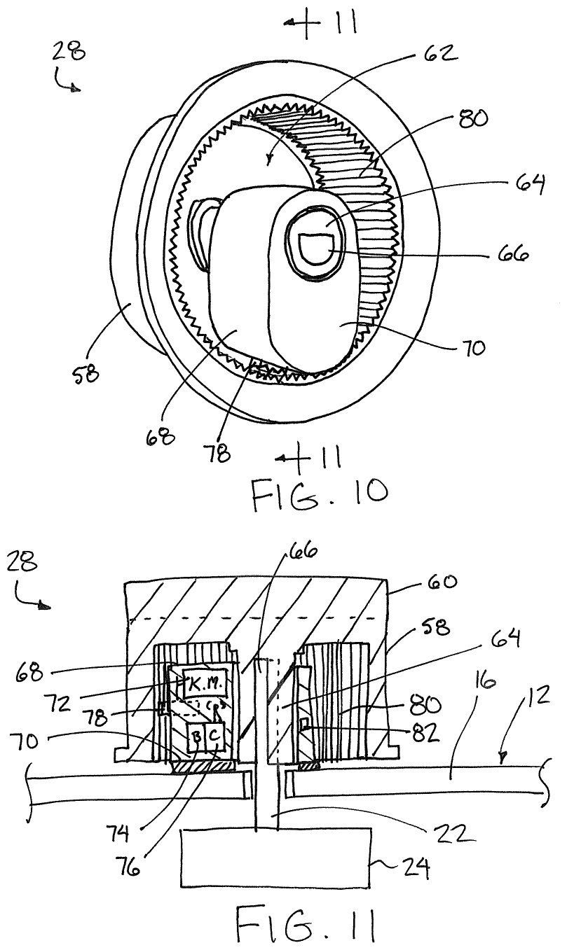

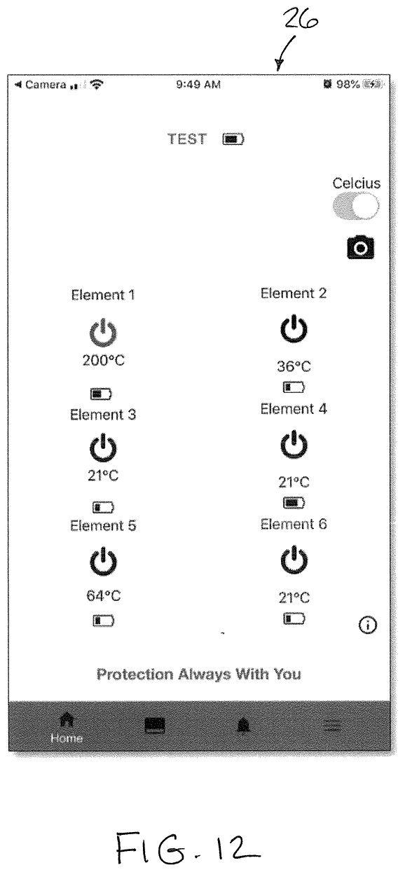

In the drawings like characters of reference indicate corresponding parts in the different figures.

### DETAILED DESCRIPTION

Following are more detailed descriptions of various related concepts related to, and embodiments of, methods and apparatuses according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

Referring to the accompanying figures there is illustrated a safety apparatus generally indicated by reference numeral 10. The apparatus 10 is particularly suited for use with an appliance, for example a stove 12 used for cooking. The apparatus 10 further communicates with an electronic device 14 of a user to execute the various functions of the apparatus as described herein.

The electronic device 14 typically comprises a portable computer, for example a tablet computer or a smartphone including an internal processor and a memory storing programming instructions thereon which are executable by the processor. The electronic device further includes (i) an interface such as a screen for outputting information and for receiving touch input from the user, (ii) buttons and a microphone for receiving touch and speech inputs from the user respectively, and (iii) speakers for outputting audible notifications to the user.

The stove 12 generally comprises a stove housing 16 having an upper surface defining a cooking surface 18 for receiving cooking receptacles thereon for cooking food. Multiple burner assemblies are supported on the cooking surface of the stove housing in which each burner assembly includes one burner 20 and one operational shaft 22 rotatably supported relative to the housing to control the heating level of the burner in the usual manner of a stove appliance. The burners receives respective cooking receptacles thereon and function to heat the receptacles for cooking food therein. The operational shaft 22 typically protrudes outwardly through a respective aperture in the housing for communication between an electronic burner controller 24 supported internally within the housing and a manual control knob fixed onto the outer end of the operational shaft externally of the housing. The user manually rotates the knob fixed onto the operational shaft 22 for controllably varying the heating level of the associated burner 20 through a range of levels including an off position, a high position opposite the off position, and various low through medium intermediate level positions between the off and high positions.

The apparatus 10 generally includes: (i) an application 26 in the form of programming instructions which are transferable onto the electronic device for storing on the memory of the device and for being executed by the processor of the device to execute the various functions described herein; (ii) a plurality of remote controlled knobs 28 which replace the manual knobs of the stove by mounting each remote controlled knob 28 on a respective operational shaft 22 for manually or automatically rotating the shaft to control the heating level of an associated burner; (iii) a safety sensor 30 arranged to be supported in proximity to the stove to sense a dangerous condition associated with one or more of the burner assemblies of the stove; and (vi) a main controller 50 of the apparatus receives sensor input from the safety sensor for comparison of the sensed data to suitable criteria to determine when the apparatus should generate an instruction for one or more of the knobs 28 to change the level or turn the associated burners to the off position as described in the following. The safety sensor 30 generally includes a sensor housing 34 which is elongate in a lateral direction between two opposing end walls 36 which are generally triangular in shape. The sensor housing further includes a rear wall 38 which is generally flat and vertical in orientation in a mounted position to span the full height of the sensor housing and the full length in the lateral direction between the opposing end walls 36. An adhesive layer 40 is supported on the rear wall for adhering the rear wall in fixed relation to an upright supporting surface such as the rear wall extending vertically upward at the rear side of the stove 12.

The sensor housing also includes a front wall 42 spanning the full height of the sensor housing by being sloped upwardly and outwardly in a forward direction from the bottom end of the rear wall. The top end of the front wall 42 and the top end of the rear wall 88 are joined to one another by a top wall 44 which is generally horizontal in orientation and which spans the full length in the lateral direction between the opposing ends 36 of the housing.

A plurality of individual burner sensors 46 are supported on the sensor housing such that each burner sensor is associated with a respective portion of the cooking surface 18 of the stove which may be a respective individual burner 20 of the stove or an area of the cooking surface encompassing part of one or more burners or multiple burners respectively. Each burner sensor 46 comprises an infrared sensor which measures heat emitted by the respective portion of the cooking surface of the stove with which it is associated.

The burner sensors 46 are mounted on the front wall of the housing such that each sensor is directed downwardly and forwardly onto the top surface of the stove for measuring heat emitted from the respective portion of the cooking surface with which it is associated. Each burner sensor 46 is recessed into a respective aperture formed in the front wall with a transparent shield fully spanning across the front wall to protect the individual sensors behind the transparent shield. Each infrared burner sensor 46 is adjustably supported relative to the housing by suitable pivotal structures such that an angular orientation of the sensor 46 about two different axes is permitted. During initial set up and calibration of the safety sensors, the individual burner sensors are each directed towards a respective portion of the cooking surface locating a respective one of the burners therein such that each sensor measures heat emitted from the respective burner with which it is associated.

The sensor housing 34 also includes a camera 48 mounted on the front wall so as to be similarly recessed within a respective aperture in the front wall so as to be covered by the transparent shield, for example a glass pane spanning the surface of the front wall. The mounting of the camera 48 within the front wall suitably orients the camera to be directed downwardly and forwardly onto the stovetop to capture an image of the entirety of the stovetop in a preferred arrangement. The camera 48 can also be adjustably supported relative to the housing by suitable pivotal structures such that an angular orientation of the camera about two different axes is permitted. During initial set up and calibration of the safety housing, the camera is directed towards the cooking surface to capture an image of the entire cooking surface including all of the burners.

A sensor controller 50, providing the function of a main controller for the apparatus, is supported inside the sensor housing. The sensor/main controller 50 comprises a processor and a memory storing programming instructions thereon executable by the processor to perform the various functions of the safety sensor as described herein. A transceiver 52 is also received within the sensor housing in communication with the main controller for wireless communication with the individual knobs 28. The main controller 50 also communicates with a wireless communications network, for example a local network such as Wi-Fi to a local modem which in turn communicates with the Internet. The application executable on the electronic device preferably uses the transceiver of the electronic device to similarly communicate over a communications network such as the Internet such that the main controller 50 of the apparatus 10 can communicate with the application 26 on the user electronic device as described herein.

Once activated, the main controller 50 of the safety sensor directly communicates with the individual burner sensors 46 to acquire heat measurements from the sensors. An activation button 54 is supported externally on the top wall of the sensor housing 34 to be actuated by a user depressing the external button. The button can also be used to deactivate the apparatus. When deactivated, the apparatus does not activate the individual burner sensors such that the temperature of the stovetop is not monitored. Once activated however, the sensors continue to measure heat from the associated portions of the cooking surface of the stove at regular intervals. The heat measurements from the individual burner sensors 46 are individually compared to respective heat thresholds stored on the main controller for determining a dangerous condition if any one of the heat measurements exceeds the prescribed heat thresholds. The dangerous condition may be determined for all of the burners collectively as a whole, or alternatively the dangerous condition may be associated with an individual burner or area of the cooking surface associated with the burner sensor 46 that detected the heat measurement that exceeded the threshold.

Once a dangerous condition has been determined, the main controller generates and transmits a notification signal to the application 26 on the user electronic device by communicating the notification over the communication network therebetween. If further criteria are met by user interaction with the application 26, the main controller subsequently receives an instruction signal from the application, or alternatively may directly generate an instruction signal based on determination of the dangerous condition, for subsequently transmitting the instruction signal to any knobs 28 of burners associated with the dangerous condition for turning off selected burners within an associated portion of the cooking surface from which the dangerous condition was determined or for turning off all burners according to the configuration of the programming instructions.

The main controller 50 is further arranged to communicate with the camera 48 for capturing images of the stovetop and storing the images on the main controller for subsequent transmission over the communications network to the application on the user electronic device. In further instances, the user may interact with the application 26 on the user electronic device so as to generate an image request from the application which is transmitted over the communications network to the main controller. The main controller receives the request signal and captures a new current image using the camera in response to the request signal, followed by subsequent transmission of the newly captured image back to the application for viewing by the user on the user electronic device.

Each of the remote controlled knobs 28 includes a main body 56 formed as a single, unitary structure of a common material which is seamless and continuous throughout. The main body 56 has an outer surface defining a cylindrical shaped lower portion 58 and an upwardly protruding rib 60 extending upward from a top end of the lower cylindrical portion 58 such that the outer surface collectively defines a gripping portion of the main body which can be gripped by the fingers of the user for rotating the knob and the operational shaft of the stove upon which the knob is mounted in fixed relation. The protruding rib 60 spans diametrically across the cylindrical lower portion 58 while protruding axially upwardly from the top end of the lower cylindrical portion 58.

A hollow cavity is formed within the interior of the body 56 which is open to the bottom end 62 thereof. A shaft mounting portion 64 of the body 56 is located within the hollow cavity in the form of a post which is concentric with the cylindrical portion 58 of the outer surface to extend downwardly from the top end of the main body to a bottom end of the shaft mounting portion 64 in proximity to the bottom end 62 of the body. A socket 66 extends axially upward from an open bottom end at the bottom end of the shaft mounting portion 64 of the body 56. The socket is non-circular in shape for meeting non-rotatably with the operational shaft of the stove. The socket is sized for interference fit with the operational shaft such that friction is sufficient to retain the main body 56 mounted in fixed relation directly upon the operational shaft 22.

The main body 56 can be gripped directly in the hand of a user for manually turning the knob and the connected operational shaft for manually adjusting the heating level of an associated burner. Alternatively, rotation of the knob can be actuated remotely in response to an instruction signal from the main controller 50 as described herein.

Actuation of the knob rotation is accomplished by a motor housing 68 received within the hollow cavity inside the main body 56 in the mounted position of the knob on the stove. The motor housing 68 includes a base having a flat bottom 70 supporting an adhesive layer on the bottom side thereof such that the motor housing can be adhered directly to an outer surface of the stove housing surrounding the operational shaft associated therewith. The motor housing 68, including the base thereof includes an aperture extending upwardly therethrough from the flat bottom 70 to receive the operational shaft 22 and the shaft mounting portion 64 of the body 56 of the knob therethrough without interference such that the knob remains readily rotatable relative to the stove together with the operational shaft relative to the motor housing 68 which is fixed relative to the stove housing.

The motor housing 68 includes a knob motor 72 supported therein in the form of an electric rotary motor driven by a battery 74 also supported within the motor housing. A knob controller 76 also within the motor housing 68 comprises a processor and a memory storing programming instructions thereon executable by the processor to perform the various functions described herein. The knob controller 76 also includes a transceiver 77 for wireless communication with the main controller 50 and/or communication with the application over the wireless communications network. The knob controller receives instruction signals from the main controller and generates appropriate actuation signals for the knob motor 72 to control the knob motor in response to commands from the main controller.

The knob motor 72 includes a rotary output which is operatively connected to a spur gear 78 rotatably supported on the motor housing to protrude from the housing 68 and engage an inner surface of the main body 56 of the knob. The spur gear is supported for rotation about an axis oriented parallel to the socket 66 of the knob and the axis of the corresponding operational shaft 22 received therein.

The main body 56 of the knob further includes a driven portion formed on the inner surface of the body in the form of a ring gear 80. The ring gear comprises a plurality of gear teeth circumferentially spaced about an axis of the knob for meshing engagement with the spur gear 78 of the knob motor 72. The ring gear 80 is integrally moulded and formed as a unitary structure with the remainder of the main body 56 including the socket 66 receiving the operational shaft 22 therein.

The motor housing 68 is formed to include a passage extending fully therethrough between opposing top and bottom sides of the motor housing to receive the operational shaft extending therethrough as well as the surrounding shaft mounting portion 64 of the main body 56. The passage through the motor housing has a diameter which is slightly larger than the outer diameter of the shaft mounting portion 64 within the hollow cavity of the main body 56 such that the knob is freely rotatable without frictional contact relative to the motor housing.

When the motor housing surrounds the operational shaft 22 and the shaft mounting portion 64 of the main body of the knob, an optional positional sensor may be operatively connected between the motor housing 68 and the main body 56 of the knob for detecting the angular position of the knob and the operational shaft connected thereto about an upright axis of the shaft relative to the motor housing fixed upon the stove housing. The angular position measured by the optional position sensor 82 can be reported to the knob controller which in turn reports to the main controller, which in turn reports to the application such that the angular position of each burner control knob is readily known by the application 26 for display to the user at any time.

The knob controller 76 includes suitable circuitry for monitoring the level of the battery 74 connected thereto such that the battery level can also be reported by the knob controller back to the main controller, which in turn reports the battery level to the application for display to the user at any time.

The application 26 generally comprises programming instructions which can be transferred to and stored on the electronic device of the user for subsequent execution of the programming instructions by the processor of the electronic device to perform the various functions described herein. The application uses the transceiver of the electronic device to communicate with the main controller 50. The application can request status information from the main controller at any time when the system has been activated. When the user interacts with the application on the electronic device, the measured position data and/or determined positions of the knobs stored in memory can be presented to the user to indicate the operational level of each operational shaft 22 and the associated burner. In addition, or alternatively to the knob position, the individual burner sensors can be used to sense heat emitted by each burner so that the heat measurements can also be recorded in association with each burner for display to the user.

As illustrated in a sample screenshot shown in FIG. 12, an individual icon can be displayed in association with each burner when each burner sensor has been calibrated with a respective burner of the stove. In instances when the stove comprises fewer burners than the six burners illustrated, the application can be programmed by the user interacting with various setting controls of the application so that individual burner sensors are associated only with the burners which are present on the stove and only the activated sensors are displayed as icons in the application.

A numerical heat measurement for each burner is displayed adjacent to the respective burner icons along with a symbol indicating the battery level associated with each knob. The burner icon on the display further includes an off button associated therewith such that the user can press the corresponding off button displayed on the touch screen to result in a corresponding instruction signal being relayed from the application back to the associated knob for actuating the motor to turn the knob to the off position.

The user interface further allows the user to interact with a temperature button displayed on the screen which then allows the user to be provided with controls for selecting a specified temperature within the operating range of the burner. Any change in the temperature setting by the user using the application results in a corresponding instruction signal being generated by the application for communication back to the knob controller through the main controller communication for corresponding actuation of the associated knob.

The application further includes a camera button displayed on the user interface of the electronic device. Actuation of the camera button allows the user to view a current image captured by the camera of the stovetop. This may be a recently captured image stored in memory. If the user desires a more current image, actuation of a refresh button causes the application to generate a request signal for a new image which is forwarded from the application back to the main controller which in turn instructs the camera to capture a new image followed by communication of the new image data back to the application for display on the electronic device.

In some instances, the application can be registered by the user under the settings commands to be associated with more than one stove appliance. In this instance, each stove appliance is provided with its own safety sensor bar having a plurality of individual burner sensors associated with the respective burners of that stove. All data communicated from the main controller 50 of each system to the common application on the user electronic device further include a unique identification associated with the sensor bar so that each sensor bar only responds to appropriate commands having the proper identification associated therewith. Likewise all information reported from the main controllers of the two systems back to the application are associated with the proper stove by the application. Suitable controls on the application allow the user to toggle between different devices being displayed by the application.

Use of the device begins with the user depressing the activation button on the sensor housing 34 to activate the individual burner sensors for monitoring heat emitted from the associated portions of the cooking surface of the stovetop. The captured heat measurements are recorded by the main controller together with image data captured by the camera for subsequent transmission of the data back to the application over the communications network. At any time, the user can activate the application for accessing the data. The user may also interact with the application for controllably varying the condition of any of the remote controlled knobs 28 as may be desired.

When the system is actively monitoring temperatures, at any time if the heat emitted from a respective portion of the cooking surface associated with one of the burners is monitored by one of the burner sensors exceeds the heat threshold stored on the main controller, the main controller automatically determines a dangerous condition associated with the affected burners or with the stove as a whole. In an exemplary automated mode, the main controller may be configured to automatically turn off the affected burner or all burners according to user preference when a dangerous condition is detected. In addition, the main controller generates an appropriate notification signal sent to the application when the dangerous condition is detected such that the application can generate a suitable alert for the user such as an audible alert or a visual alert in the usual manner of notifications on a personal electronic device.

In an interactive mode of operation, when a dangerous condition is determined, the main controller initially generates a notification signal for communication to the application on the user electronic device. The application on the electronic device in this instance generates a prompt for the user using audible and/or visual indications through the user interface of the electronic device. The prompt may be a query such as a request for the user to acknowledge that they are at the location of the stove or a request for the user to confirm that the stove should be turned off. If a user responds by confirming their presence at the stove or confirming that they do not want the stove to be turned off, the system will not take further action to actively turn off the burner against the user's wishes. Alternatively, if the user responds by confirming that they are not present at the stove or by confirming that they do wish the stove to be turned off, then the system will immediately generate appropriate instruction signals for the affected knobs to turn off the affected burners of the stove. A lack of user response to the prompt generated by the application is determined by the system as confirmation that the user is not present at the stove such that the system will automatically generate an instruction signal to turn off the affected burners of the stove.

As described herein, the apparatus comprises remote controlled knobs with a safety sensor according to the present disclosure. The knobs of the device are configured for universal use and replace the existing knobs on a stove appliance. Within an interior of the knob assembly motorized gears are configured to rotate the knob to the off position and turn the burner off from a remote location though an application hosted on an electronic device.

The sensor of the device is generally adapted to sense, through an infrared sensor, the presence of a dangerous condition. The sensor is generally a bar shape configured for mounting above the stove top to monitor heat levels. Preferably the sensor is fastened to a surface above the application by a peel and stick adhesive. The sensor includes a built-in camera and heat sensor configured to communicate with the application to verify that the stove is off, or if not off enable a user or turn it off. The sensor includes a plurality of adjustable, infrared temperature sensors which are angled at the burners. The heat sensors enable monitoring and may turn off the stove top when an unsafe heat level is reached.

While the invention has been described above in terms of specific embodiments, it is to be understood that the invention is not limited to these disclosed embodiments.

Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

Since various modifications can be made in my invention as herein above described, and many apparently widely different embodiments of same made, it is intended that all matter contained in the accompanying specification shall be interpreted as illustrative only and not in a limiting sense.

1. An apparatus for use with an electronic device for controlling operation of a stove having a stove housing and a cooking surface supporting two or more burner assemblies thereon, each burner assembly including a burner for cooking and an operational shaft associated with the burner to control a heating level of the burner, the apparatus comprising:
an application comprising programming instructions arranged to be executed by the electronic device;
a plurality of remote controlled knobs arranged to be operatively connected to the operational shafts of the burner assemblies respectively;
a safety sensor arranged to be supported above the stove so as to be configured to sense a dangerous condition;
a main controller operatively connected to the safety sensor so as to be arranged to notify the application of the dangerous condition;
the application being configured to generate a user prompt responsive to notification of the dangerous condition and generate an instruction signal for the main controller to instruct one or more of the remote controlled knobs to turn off the operational shaft connected thereto based upon a user response to the user prompt.

2. The apparatus according to claim 1 wherein the application is configured to instruct the one or more remote controlled knobs to turn off the operational shaft connected thereto based upon the user response being a confirmation that the user is not in proximity to the stove.

3. The apparatus according to claim 1 wherein the application is configured to instruct the one or more remote controlled knobs to turn off the operational shaft connected thereto based upon the user response being non-responsive to the user prompt.

4. The apparatus according to claim 1 wherein the safety sensor comprises a plurality of infrared sensors associated with respective portions of the cooking surface, each infrared sensor being configured to measure heat being emitted by the respective portion of the cooking surface and determine the dangerous condition if the measured heat from any one infrared sensor exceeds a prescribed heat threshold.

5. The apparatus according to claim 4 wherein the instruction signal is associated with all of the remote controlled knobs such that all of the remote controlled knobs are instructed to be turned off by the main controller in response to determination of the dangerous condition by any one of the infrared sensors.

6. The apparatus according to claim 1 wherein the safety sensor comprises a sensor housing and a plurality of infrared sensors commonly mounted on the sensor housing so as to be adjustable in orientation relative to the sensor housing whereby each infrared sensor is associated with a respective portion of the cooking surface, each infrared sensor being configured to measure heat being emitted by the respective portion of the cooking surface and determine the dangerous condition if the measured heat from that infrared sensor exceeds a prescribed heat threshold.

7. The apparatus according to claim 6 wherein the safety sensor further comprises an activation button supported on the sensor housing, the plurality of infrared sensors being inoperative until commonly activated by depressing the activation button on the sensor housing.

8. The apparatus according to claim 6 wherein the sensor housing comprises (i) a rear wall including an adhesive layer thereon so as to be arranged to adhere the sensor housing to an upright supporting surface adjacent to the stove and (ii) a front wall that is sloped upwardly and outwardly away from the rear wall, wherein the front wall supports the plurality of infrared sensors thereon.

9. The apparatus according to claim 6 further comprising a camera supported on the sensor housing and configured to capture an image of the burner assemblies and communicate the image to the application.

10. The apparatus according to claim 9 wherein the image is communicated to the application in response to determination of the dangerous condition.

11. The apparatus according to claim 9 wherein the image is captured and communicated to the application in response to a request signal from the application.

12. The apparatus according to claim 1 wherein each remote controlled knob comprises:
a gripping portion supported on the respective operational shaft of the stove externally of the stove housing so as to be arranged to be gripped in a hand of a user;
a base portion arranged to be fixed relative to the stove housing;
a knob motor arranged to drive rotation of the gripping portion and the operational shaft connected thereto relative to the stove housing; and
a knob controller arranged to activate the knob motor in response to the instruction signal.

13. The apparatus according to claim 12 wherein the gripping portion of each knob comprising a main body including (i) a shaft mounting socket that directly mounts the gripping portion on the respectively operational shaft of the stove and (ii) a driven portion directly coupled to an output of the knob motor to drive rotation of the operational shaft directly through the gripping portion.

14. The apparatus according to claim 13 wherein the driven portion of the main body of the knob comprises a ring gear and the output of the knob motor comprises a spur gear in meshing engagement with the ring gear.

15. The apparatus according to claim 14 wherein the main body of the knob comprises a single unitary body forming both the shaft mounting socket and the ring gear integrally thereon.

16. The apparatus according to claim 13 wherein the base portion of the knob includes an adhesive layer thereon so as to be arranged to adhere the base portion to the stove housing.

17. An apparatus for controlling operation of a stove having a stove housing and a cooking surface supporting two or more burner assemblies thereon, each burner assembly including a burner for cooking and an operational shaft associated with the burner to control a heating level of the burner, the apparatus comprising:
a plurality of remote controlled knobs arranged to be operatively connected to the operational shafts of the burner assemblies respectively;
a safety sensor arranged to be supported above the stove so as to be configured to sense a dangerous condition;
the safety sensor comprising (i) a sensor housing and (ii) a plurality of infrared sensors commonly mounted on the sensor housing so as to be associated with respective portions of the cooking surface;
each infrared sensor being configured to measure heat being emitted by the respective portion of the cooking surface and determine a dangerous condition if the measured heat exceeds a prescribed heat threshold;
a main controller in operative communication with the remote controlled knobs and the safety sensor so as to be arranged to transmit an instruction signal to the remote controlled knobs to turn off the knobs in response to determination of the dangerous condition by any one of the infrared sensors.

18. The apparatus according to claim 17 wherein the safety sensor further comprises an activation button supported on the sensor housing, the plurality of infrared sensors being inoperative until commonly activated by depressing the activation button on the sensor housing.

19. The apparatus according to claim 17 wherein the sensor housing comprises (i) a rear wall including an adhesive layer thereon so as to be arranged to adhere the sensor housing to an upright supporting surface adjacent to the stove and (ii) a front wall that is sloped upwardly and outwardly away from the rear wall, wherein the front wall supports the plurality of infrared sensors thereon such that the infrared sensors are arranged to be directed downwardly and forwardly onto the cooking surface of the stove.

20. An apparatus for use with an electronic device for controlling operation of a stove having a stove housing and a cooking surface supporting two or more burner assemblies thereon, each burner assembly including a burner for cooking and an operational shaft associated with the burner to control a heating level of the burner, the apparatus comprising:
a safety sensor arranged to be supported above the stove so as to be configured to sense a dangerous condition;
a plurality of remote controlled knobs arranged to be operatively connected to the operational shafts of the burner assemblies respectively;
a main controller in operative communication with the remote controlled knobs and the safety sensor so as to be arranged to transmit an instruction signal to the remote controlled knobs to turn off the knobs in response to determination of the dangerous condition by the safety sensor;
each remote controlled knob comprising:
(i) a gripping portion supported on the respective operational shaft of the stove externally of the stove housing so as to be arranged to be gripped in a hand of a user;
(ii) a base portion arranged to be fixed relative to the stove housing;
(iii) a knob motor arranged to drive rotation of the gripping portion and the operational shaft connected thereto relative to the stove housing; and
(iv) a knob controller arranged to activate the knob motor in response to the instruction signal from the main controller;
(v) the gripping portion of each knob comprising a main body including (a) a shaft mounting socket that directly mounts the gripping portion on the respectively operational shaft of the stove and (b) a driven portion directly coupled to an output of the knob motor to drive rotation of the operational shaft directly through the gripping portion, the driven portion of the main body of the knob comprises a ring gear;
(vi) the output of the knob motor comprises a spur gear in meshing engagement with the ring gear;
wherein the main body of the knob comprises a single unitary body forming both the shaft mounting socket and the ring gear integrally thereon.
